(19) United States
(12) Patent Application Publication
(10) Pub. No.: US 2005/0270704 A1
(43) Pub. Date: Dec. 8, 2005

(54) Magnetoresistance effect film and magnetoresistance effect head

(75) Inventors: Hidehiko Suzuki, Kawasaki (JP); Kenji Noma, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/970,764

(22) Filed: Oct. 21, 2004

(30) Foreign Application Priority Data
Jun. 8, 2004 (JP) 2004-170002

(51) Int. Cl. G11B 5/33; G11B 5/127

(52) U.S. Cl. 360/324.11

(57) ABSTRACT

The magnetoresistance effect film has a magnetic oxide layer for fixing a magnetizing direction of a pinned magnetic layer and a greater MR ratio. The magnetoresistance effect film has a layered structure, in which a seed layer, the magnetic oxide layer, the pinned magnetic layer, a nonmagnetic intermediate layer, and a free magnetic layer are layered in this order, wherein the seed layer is an oxide layer being made of or including an oxide, which has a sodium chrolide (NaCl) type crystal structure, whose energy gap is 1 eV or more, and which is nonmagnetizable at room temperature, and wherein the magnetic oxide layer is an oxide layer including ferrite, which includes cobalt.

### BACKGROUND OF THE INVENTION

The present invention relates to a magnetoresistance effect film, which has high magnetic resistance ratio (MR ratio) and a magnetoresistance effect head including said magnetoresistance effect film.

Surface recording density of hard disks are increasing higher and higher. By increasing the surface recording density, a required area of a hard disk for each bit can be smaller, so that a high sensitive reproducing head is required in a hard disk drive unit.

A basic structure of a conventional magnetoresistance effect film is shown in FIG. 5. An antiferromagnetic layer 11, a pinned magnetic layer 4, a nonmagnetic intermediate layer 5, a free magnetic layer 6 and a protection layer 7 are piled therein. Even if a magnetic field is applied to the pinned magnetic layer 4 from a recording medium (a hard disk), a magnetizing direction of the pinned magnetic layer 4 must be fixed. To fix the magnetizing direction, the antiferromagnetic layer 11, which is made of an antiferromagnetic material, e.g., platinum-manganese (PtMn), is provided to contact the pinned magnetic layer 4. With this structure, the layers 4 and 11 are coupled by an exchange coupling magnetic field therebetween, so that the magnetizing direction of the pinned magnetic layer 4 can be fixed.

A magnetoresestance effect is caused by electrons running boundary surfaces of the layers 4, 5 and 6. However, since the antiferromagnetic layer 11 is usually made of an alloy, an electric current runs in the layer 11. The current is called a shunt current, which lowers the MR ratio. A specific resistance of the alloy of the antiferromagnetic layer 11 is greater than those of other layers 4, 6, etc., but thickness of the layer 11 with respect to total thickness of the magnetoresistance effect film is great, e.g., about 40%, so that the shunt current running through the layer 11 cannot be ignored.

Using an insulating material instead of the antiferromagnetic layer 11 is disclosed in two documents: (1) M. J. Carey, S. Maat, R. Farrow, R. Marks, P. Nguyen, P. Rice, A Kellock and B. A. Gurney, Digest Intermag Europe 2002, BP2; and (2) S. Maat, M. J. Carey, Eric E. Fullerton, T. X. Le, P. M. Rice and B. A. Gurney, Appl. Phys. Lett. 81, 520 (2002). In the two documents, cobalt-ferrite (CoFe₂O₄) is used instead of the antiferromagnetic layer 11 of the conventional magnetoresistance effect film. The cobalt-ferrite is an insulating material and a ferri magnetic material having a great coercive force. Therefore, the magnetizing direction of the pinned magnetic layer 4 can be fixed with reducing the shunt current. Especially, in the document (2), a cobalt oxide, e.g., CoO, Co₃O₄, is used as a base layer (a seed layer) of the cobalt-ferrite. In comparison with the magnetoresistance effect film having no base layer, the MR ratio can be greater.

An example of a β-H (resistivity-external magnetic field dependency) characteristic of a magnetoresistance effect film, which has the ferri magnetic material, e.g., cobalt-ferrite, is shown in FIG. 6. A strength of a coupling magnetic field Hc(pin) defined in FIG. 6 depends on that of an exchange coupling magnetic field between the oxide magnetic layer and the pinned magnetic layer. The value Hc(pin) influences long term reliability of the magnetoresistance effect film, so the MR ratio must be increased with maintaining the value Hc(pin) great so as to highly increase the magnetic recording density.

### SUMMARY OF THE INVENTION

The present invention has been invented to solve the problems of the conventional magnetoresistance film.

An object of the present invention is to provide a magnetoresistance effect film, which has a magnetic oxide layer for fixing a magnetizing direction of a pinned magnetic layer and which has a greater MR ratio.

Another object is to provide a magnetoresistance effect head employing the magnetoresistance effect film.

To achieve the objects, the present invention has following structures.

Namely, a first basic structure of the magnetoresistance effect film has a layered structure, in which a seed layer, a magnetic oxide layer, a pinned magnetic layer, a nonmagnetic intermediate layer, and a free magnetic layer are layered in this order, wherein the seed layer is an oxide layer being made of or including an oxide, which has a sodium chrolide (NaCl) type crystal structure, whose energy gap is 1 eV or more, and which is nonmagnetizable at room temperature, and wherein the magnetic oxide layer is an oxide layer including ferrite, which includes cobalt.

A second basic structure of the magnetoresistance effect film has a layered structure, in which a seed layer, a magnetic oxide layer, a pinned magnetic layer, a nonmagnetic intermediate layer, and a free magnetic layer are layered in this order, wherein the seed layer is an oxide layer being made of or including a metallic oxide, which has at least one lattice constant of 0.406-0.432 nm, whose energy gap is 1 eV or more, and which is nonmagnetizable at room temperature, and wherein the magnetic oxide layer is an oxide layer including ferrite, which includes cobalt.

A third basic structure of the magnetoresistance effect film has a layered structure, in which a seed layer, a magnetic oxide layer, a pinned magnetic layer, a nonmagnetic intermediate layer, and a free magnetic layer are layered in this order, wherein the seed layer is an oxide layer being made of or including a metallic oxide, which has at least one lattice constant of 0.813-0.863 nm, whose energy gap is 1 eV or more, and which is nonmagnetizable at room temperature, and wherein the magnetic oxide layer is an oxide layer including ferrite, which includes cobalt.

Further, the magnetoresistance effect head of the present invention includes any of the magnetoresistance effect films.

In the present invention, the MR ratio of the the magnetoresistance effect film can be greater than that of the conventional film disclosed in the document (2), in which a cobalt oxide is used as the seed layer. Further, the value Hc(pin) of the coupling magnetic field can be almost equal to that of the conventional film, in which the cobalt oxide is used. Therefore, in the present invention, the MR ratio can be increased with maintaining the value Hc(pin) great, so that the recording density of a magnetic hard disc can be higher and higher.

### BRIEF DESCRIPTION OF THE DRAWINGS

Embodiments of the present invention will now be described by way of examples and with reference to the accompanying drawings, in which:

FIG. 1 is an explanation view of a magnetoresistance effect film of an embodiment of the present invention;

FIG. 2 is an explanation view of a magnetoresistance effect head;

FIG. 3 is an explanation view of a magnetoresistance effect film having a synthetic ferrimagnet structure;

FIG. 4 is an explanation view of a magnetoresistance effect film having a dual structure;

FIG. 5 is an explanation view of the conventional magnetoresistance effect film; and

FIG. 6 is a graph showing the β-H (resistivity-external magnetic field dependency) characteristic of the conventional magnetoresistance effect film, which has the ferri magnetic material, and defining the value Hc(pin).

### DETAILED DESCRIPTION OF THE EMBODIMENTS

Preferred embodiments of the present invention will now be described in detail with reference to the accompanying drawings.

A basic structure of the magnetoresistance effect film of the present embodiment is shown in FIG. 1. An oxide layer 3, which includes ferrite including cobalt, is formed on a magnesium oxide layer 2, which acts as a seed layer, and a pinned magnetic layer 4, a nonmagnetic intermediate layer 5, a free magnetic layer 6 and a protection layer 7 are layered on the oxide layer 3 in this order.

The inventors performed an experiment.

Three samples of magnetoresistance effect films were formed on silicon substrates by magnetron spattering. Details of the samples were as follows:
Sample “A”: CoFe₂O₄ 10/CoFe/Cu/Co/NiFe/Cu/Ta [nm]
Sample “B”: (CoO_Co₃O₄) 10/CoFe₂O₄ 10/CoFe/Cu/Co/NiFe/Cu/Ta [nm]
Sample “C”: MgO 10/CoFe₂O₄ 10/CoFe/Cu/Co/NiFe/Cu/Ta [nm]

Note that, from the bottom layers, the CoFe layers were the pinned magnetic layers 4; the Cu layers were the nonmagnetic intermediate layers 5; the Co/NiFe layers were the free magnetic layers 6; the Cu layers were nonmagnetic layers; and the Ta layers were the protection layers 7.

The sample “A” had no seed layer; the sample “B” were disclosed in the document (2); and the sample “C” corresponded to the magnetoresistance effect film of the present embodiment. In the sample “B”, cobalt oxide (a solid solution of CuO and Co₃O₄) was used as the seed layer; in the sample “C”, magnesium oxide, which had a sodium chloride (NaCl) type crystal structure, was used as the seed layer. In all of the samples “A”, “B” and “C”, cobalt-ferrite was used as the magnetic oxide layers, and the structures of the layers above the magnetic oxide layer were same.

Characteristics of the samples “A”, “B” and “C” are shown in TABLE.

TABLE

| | MR ratio [%] | Δ ρ/t [Ω] | ρ/t [Ω] | Hc(pin) [kA/m] |
|---|---|---|---|---|
| Sample “A” | 13.42 | 4.87 | 36.3 | 161 |
| Sample “B” | 15.38 | 5.06 | 32.9 | 281 |
| Sample “C” | 17.61 | 5.61 | 31.8 | 274 |

The MR ratio of the sample “A” was 13.42%; that of the sample “B” was 15.38%, which was greater than the sample “A”; and that of the sample “C” was 17.61%, which was greater than the sample “B”.

The Hc(pin) value of the sample “A” was smaller than others, but those of the samples “B” and “C” were nearly equal.

Sheet resistance (ρ/t) of the sample “A” was 36.3 Ω; that of the sample “B” was 32.9 Ω, which was smaller than the sample “A”; and that of the sample “C” was 31.8 Ω, which was smaller than the sample “B”. The reduction of the sheet resistance in the sample “C” was caused by improvement of crystallinity of the whole film. By improving the crystallinity, crystal grain boundary was reduced and electron scattering was restrained. According to the results, the crystallinity of the magnetoresistance film can be improved and the MR ratio thereof can be increased by using the seed layers. Magnesium oxide is superior, as the seed layer, to cobalt oxide.

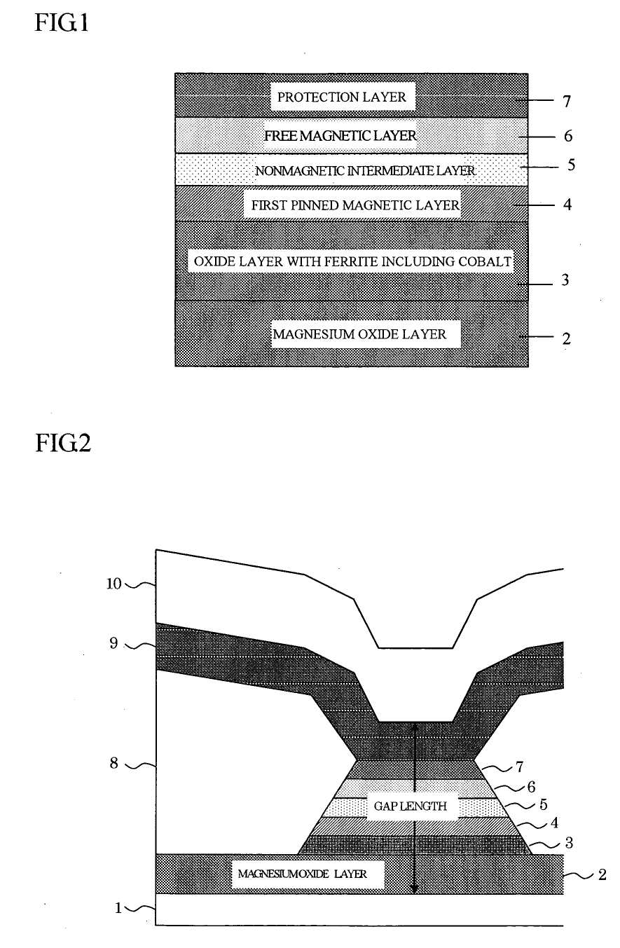

In another embodiment, the seed layer may be used as an insulating gap layer. This embodiment is shown in FIG. 2. In FIG. 2, a magnesium oxide layer 2 is formed on a lower magnetic shielding layer 1 as a lower insulating gap layer. Then, a magnetoresistance film, in which the oxide layer 3, which includes ferrite including cobalt, the pinned magnetic layer 4, the nonmagnetic intermediate layer 5, the free magnetic layer 6 and the protection layer 7 are layered in this order, is formed on the oxide layer 2. Both side faces of the magnetoresistance effect film are etched by ion milling, so that they are formed into slope faces. Magnetic biasing layers and electrodes 8 are respectively formed on the both sides of the magnetoresistance effect film. An upper insulating gap layer 9 electrically insulates an upper magnetic shielding layer 10 from the electrodes and the magnetoresistance effect film.

Alumina is usually used for the insulating gap layers. In the embodiment shown in FIG. 2, the oxide, e.g., magnesium oxide, acts as the insulating gap layer and the seed layer of the magnetoresistance effect film.

In FIG. 2, the whole insulating gap layer is made of the material of the seed layer. In the case of a multilayered insulating gap layer, the uppermost layer should be made of the material of the seed layer. In comparison with the magnetoresistance effect film in which the seed layer and the insulating gap layer are separately formed, a gap length, which is a distance between the lower shielding layer 1 and the upper shielding layer 10 (see FIG. 2), of the present embodiment can be shortened. By shortening the gap length, resolution of a reproducing magnetic head can be improved, so that magnetic recording density of a hard disc can be increased.

In the case of employing the seed layer acting as the insulating gap layer, the desired material of the seed layer has high insulativity, and it is nonmagnetizable at room temperature. If cobalt oxide is used for the seed layer as disclosed in the document (2), following problems will occur. Firstly, energy gap of cobalt oxide is low (0.6-0.7 eV) so that cobalt oxide has properties like a semiconductor. Therefore, a probability of occurring bad insulation must be high. Cobalt oxide is an antiferromagnetic material, whose Neel temperature is about 290 K, so it will be exchange-coupled with the lower shielding layer 1 in a prescribed temperature range. If cobalt oxide is coupled with the lower shielding layer 1, soft magnetic characteristics of the lower shielding layer 1 are made worse, so that magnetic shielding function is lowered. On the other hand, the energy gap of magnesium oxide of the present embodiment is a nonmagnetizable material and has energy gap of about 7.3 eV. Therefore, the above described problems of cobalt oxide do not occur. Magnesium oxide is superior, in insulativity and nonmagnetism as the seed layer or the insulating gap layer, to cobalt oxide.

Sodium dioxide (NaO₂), magnesium monoxide (MgO), potassium dioxide (KO₂), calcium monoxide (CaO), scandium monoxide (ScO), titanium monoxide (TiO), vanadium monoxide (VO), manganese monoxide (MnO), iron monoxide (FeO), strontium monoxide (SrO), cadmium monoxide (CdO), barium monoxide (BaO), tantalum monoxide (TaO), cerium monoxide (CeO), neodymium monoxide (NdO), samarium monoxide (SmO) and ytterbium monoxide (YbO) have the NaCl type crystal structures and high insulativity, and they are nonmagnetizable at room temperature as well as magnesium oxide. Therefore, one of the oxides selected from above described group or a solid solution including one of oxides selected from the group can be used for the seed layer or the insulating gap layer.

Further, other materials capable of lattice-matching with cobalt-ferrite of the oxide layer 3 may be used for the seed layer or the insulating gap layer. Cobalt-ferrite is a cubic system material constituted four sub-lattices, and its lattice constant is 0.838 nm. Therefore, it lattice-matches with materials whose lattice constants are around 0.419 nm or 0.838 nm. If lattice mismatch rate is 3% or less, there is possibility of lattice-matching. Therefore, ranges of the lattice constants for lattice match are 0.406-0.432 nm and 0.813-0.863 nm.

Oxide materials which have high insulativity and which are nonmagnetizable at room temperature are known. In the lattice constant range of 0.406-0.432 nm, the oxide materials are sodium dioxide (NaO₂), magnesium monoxide (MgO), potassium trioxide (KO₃), titanium monoxide (TiO), vanadium monoxide (VO), iron monoxide (FeO), copper monoxide (Cu₂O), rubidium dioxide (Rb₂O₂), niobium monoxide (NbO), cesium monoxide (Cs₂O) and cesium dioxide (Cs₂O₂). In the lattice constant range of 0.813-0.863 nm, the material is chromium trioxide (CrO₃).

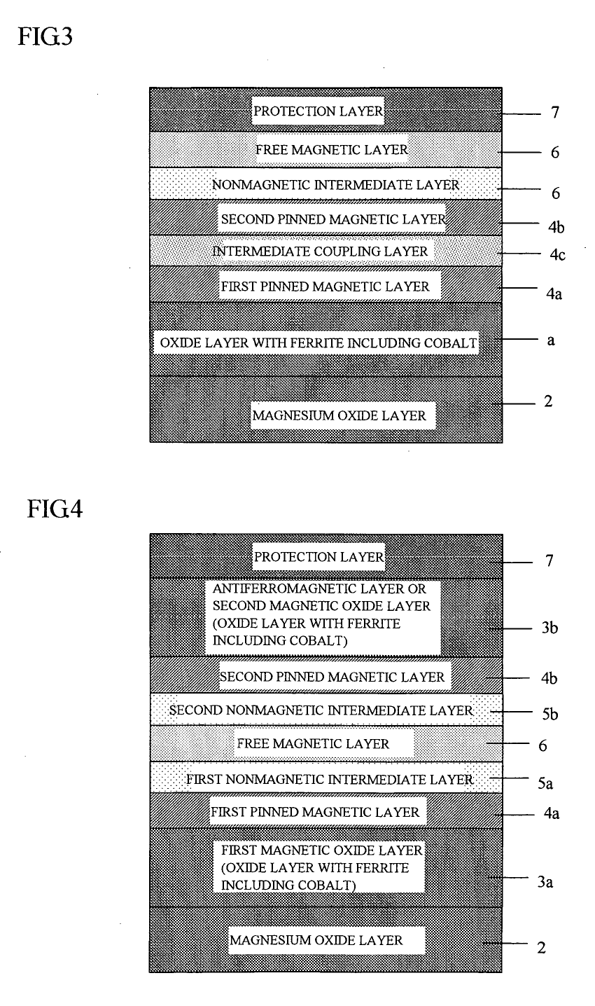

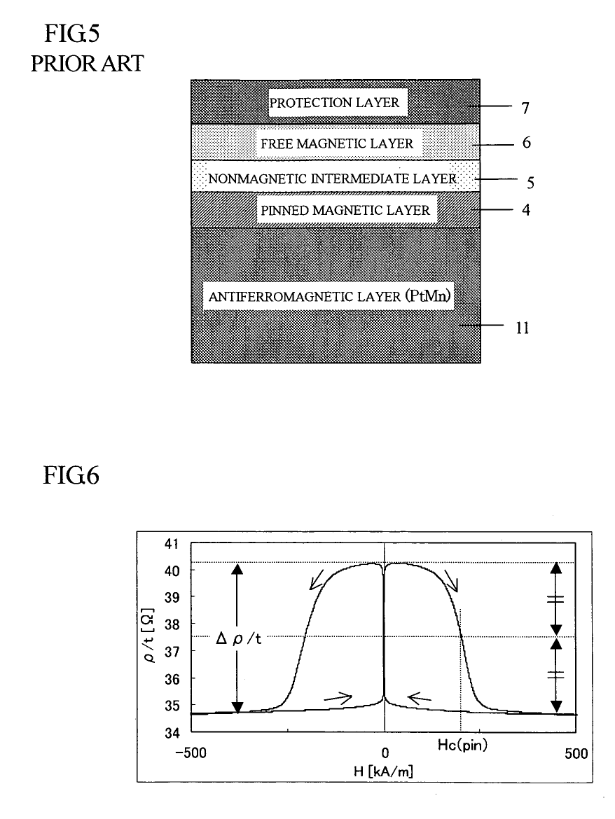

Other embodiments of the magnetoresistance effect film of the present invention are shown in FIGS. 3 and 4.

The magnetoresistance effect film shown in FIG. 1 has the one-layered pinned magnetic layer 4. On the other hand, in the embodiment shown in FIG. 3, the pinned magnetic layer has a three-layered structure constituted by a first pinned magnetic layer 4a, an intermediate coupling layer 4c and a second pinned magnetic layer 4b. This structure is called “synthetic ferrimagnet structure”. Ruthenium (Ru), iridium (Ir), rhodium (Rh), chromium (Cr), etc. are used for the intermediate coupling layer 4c. The first and second pinned magnetic layers 4a and 4b are antiferromagnetically coupled by the intermediate coupling layer 4c. With this structure, the value of Hc(pin) can be increased, so that long term reliability of the magnetoresistance effect film can be improved.

In the embodiment shown in FIG. 4, the seed layer (magnesium oxide layer) 2, a first magnetic oxide layer 3a, the first pinned magnetic layer 4a, a first nonmagnetic intermediate layer 5a, the free magnetic layer 6, a second nonmagnetic intermediate layer 5b, the second pinned magnetic layer 4b, an antiferromagnetic layer (or a second magnetic oxide layer) 3b and the protection layer 7 are layered in this order. Two magnetoresistance effect parts, each of which is constituted by the pinned magnetic layer, the nonmagnetic layer and the free magnetic layer so as to gain the magnetoresistance effect, are included in the film. This structure is called “dual structure”. By employing the dual structure, great MR ratio can be gained. Platinum-manganese (PtMn), aradium-platinum-manganese (PdPtMn), iridium-manganese (IrMn), etc. are used for the antiferromagnetic layer 3b. Further, the second magnetic oxide layer made of, for example, the oxide including ferrite, which includes cobalt, may be formed instead of the antiferromagnetic layer 3b. Note that, the first pinned magnetic layer 4a and the second pinned magnetic layer 4b may have the synthetic ferrimagnet structure as well as the embodiment shown in FIG. 3.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A magnetoresistance effect film having a layered structure, in which a seed layer, a magnetic oxide layer, a pinned magnetic layer, a nonmagnetic intermediate layer, and a free magnetic layer are layered in this order,
wherein said seed layer is an oxide layer being made of or including an oxide, which has a sodium chrolide (NaCl) type crystal structure, whose energy gap is 1 eV or more, and which is nonmagnetizable at room temperature, and
wherein said magnetic oxide layer is an oxide layer including ferrite, which includes cobalt.

2. The magnetoresistance effect film according to claim 1,
wherein the oxide of said seed layer, which has the sodium chloride type crystal structure, is one selected from a group including sodium dioxide (NaO₂), magnesium monoxide (MgO), potassium dioxide (KO₂), calcium monoxide (CaO), scandium monoxide (ScO), titanium monoxide (TiO), vanadium monoxide (VO), manganese monoxide (MnO), iron monoxide (FeO), strontium monoxide (SrO), cadmium monoxide (CdO), barium monoxide (BaO), tantalum monoxide (TaO), cerium monoxide (CeO), neodymium monoxide (NdO), samarium monoxide (SmO) and ytterbium monoxide (YbO), or a solid solution including one selected from said group.

3. A magnetoresistance effect film having a layered structure, in which a seed layer, a magnetic oxide layer, a pinned magnetic layer, a nonmagnetic intermediate layer, and a free magnetic layer are layered in this order,
wherein said seed layer is an oxide layer being made of or including a metallic oxide, which has at least one lattice constant of 0.406-0.432 nm, whose energy gap is 1 eV or more, and which is nonmagnetizable at room temperature, and
wherein said magnetic oxide layer is an oxide layer including ferrite, which includes cobalt.

4. The magnetoresistance effect film according to claim 3,
wherein the oxide of said seed layer is one selected from a group including sodium dioxide (NaO₂), magnesium monoxide (MgO), potassium trioxide (KO₃), titanium monoxide (TiO), vanadium monoxide (VO), iron monoxide (FeO), copper monoxide (Cu₂O), rubidium dioxide (Rb₂O₂), niobium monoxide (NbO), cesium monoxide (Cs₂O) and cesium dioxide (Cs₂O₂), or a solid solution including one selected from said group.

5. A magnetoresistance effect film having a layered structure, in which a seed layer, a magnetic oxide layer, a pinned magnetic layer, a nonmagnetic intermediate layer, and a free magnetic layer are layered in this order,
wherein said seed layer is an oxide layer being made of or including a metallic oxide, which has at least one lattice constant of 0.813-0.863 nm, whose energy gap is 1 eV or more, and which is nonmagnetizable at room temperature, and
wherein said magnetic oxide layer is an oxide layer including ferrite, which includes cobalt.

6. The magnetoresistance effect film according to claim 5,
wherein said seed layer is made of chromium trioxide (CrO₃) or a solid solution including chromium trioxide (CrO₃).

7. The magnetoresistance effect film according to claim 1,
wherein said seed layer is used as a part or a whole of an insulating gap layer.

8. The magnetoresistance effect film according to claim 1,
wherein said pinned magnetic layer includes a first pinned magnetic layer, an intermediate coupling layer, and a second pinned layer, and
wherein the first pinned magnetic layer and the second pinned magnetic layer are antiferromagnetically coupled by an exchange coupling magnetic field.

9. The magnetoresistance effect film according to claim 8,
wherein said intermediate coupling layer is made of one selected from a group including ruthenium (Ru), iridium (Ir), rhodium (Rh) and chromium (Cr), or an alloy including at least one selected from said group.

10. A magnetoresistance effect head including a magnetoresistance effect film, which has a layered structure, in which a seed layer, a magnetic oxide layer, a pinned magnetic layer, a nonmagnetic intermediate layer, and a free magnetic layer are layered in this order,
wherein said seed layer is an oxide layer being made of or including an oxide, which has a sodium chrolide (NaCl) type crystal structure, whose energy gap is 1 eV or more, and which is nonmagnetizable at room temperature, and
wherein said magnetic oxide layer is an oxide layer including ferrite, which includes cobalt.

11. The magnetoresistance effect head according to claim 10,
wherein the oxide of said seed layer, which has the sodium chloride type crystal structure, is one selected from a group including sodium dioxide (NaO₂), magnesium monoxide (MgO), potassium dioxide (KO₂), calcium monoxide (CaO), scandium monoxide (ScO), titanium monoxide (TiO), vanadium monoxide (VO), manganese monoxide (MnO), iron monoxide (FeO), strontium monoxide (SrO), cadmium monoxide (CdO), barium monoxide (BaO), tantalum monoxide (TaO), cerium monoxide (CeO), neodymium monoxide (NdO), samarium monoxide (SmO) and ytterbium monoxide (YbO), or a solid solution including one selected from said group.

12. The magnetoresistance effect head according to claim 10,
wherein said seed layer is used as a part or a whole of an insulating gap layer.

13. The magnetoresistance effect head according to claim 10,
wherein said pinned magnetic layer includes a first pinned magnetic layer, an intermediate coupling layer, and a second pinned layer, and
wherein the first pinned magnetic layer and the second pinned magnetic layer are antiferromagnetically coupled by an exchange coupling magnetic field.

14. A magnetoresistance effect head including a magnetoresistance effect film, which has a layered structure, in which a seed layer, a magnetic oxide layer, a pinned magnetic layer, a nonmagnetic intermediate layer, and a free magnetic layer are layered in this order,
wherein said seed layer is an oxide layer being made of or including a metallic oxide, which has at least one lattice constant of 0.406-0.432 nm, whose energy gap is 1 eV or more, and which is nonmagnetizable at room temperature, and
wherein said magnetic oxide layer is an oxide layer including ferrite, which includes cobalt.

15. The magnetoresistance effect head according to claim 14,
wherein the oxide of said seed layer is one selected from a group including sodium dioxide (NaO₂), magnesium monoxide (MgO), potassium trioxide (KO₃), titanium monoxide (TiO), vanadium monoxide (VO), iron monoxide (FeO), copper monoxide (Cu₂O), rubidium dioxide (Rb₂O₂), niobium monoxide (NbO), cesium monoxide (Cs₂O) and cesium dioxide (Cs₂O₂), or a solid solution including one selected from said group.

16. The magnetoresistance effect head according to claim 14,
wherein said seed layer is used as a part or a whole of an insulating gap layer.

17. The magnetoresistance effect head according to claim 14,
wherein said pinned magnetic layer includes a first pinned magnetic layer, an intermediate coupling layer, and a second pinned layer, and
wherein the first pinned magnetic layer and the second pinned magnetic layer are antiferromagnetically coupled by an exchange coupling magnetic field.

18. A magnetoresistance effect head including a magnetoresistance effect film, which has a layered structure, in which a seed layer, a magnetic oxide layer, a pinned magnetic layer, a nonmagnetic intermediate layer, and a free magnetic layer are layered in this order,
wherein said seed layer is an oxide layer being made of or including a metallic oxide, which has at least one lattice constant of 0.813-0.863 nm, whose energy gap is 1 eV or more, and which is nonmagnetizable at room temperature, and
wherein said magnetic oxide layer is an oxide layer including ferrite, which includes cobalt.

19. The magnetoresistance effect head according to claim 18,
wherein said seed layer is made of chromium trioxide (CrO₃) or a solid solution including chromium trioxide (CrO₃).

20. The magnetoresistance effect head according to claim 18,
wherein said seed layer is used as a part or a whole of an insulating gap layer.
